(19) United States
(12) Patent Application Publication
(10) Pub. No.: US 2008/0020924 A1
(43) Pub. Date: Jan. 24, 2008

(54) Method of fabricating platinum alloy electrocatalysts for membrane fuel cell applications

(75) Inventors: King-Tsai Jeng, Longtan Township (TW); Chun-Ching Chien, Taipei City (TW)

Correspondence Address: TROXELL LAW OFFICE PLLC, 5205 LEESBURG PIKE, SUITE 1404, FALLS CHURCH, VA, 22041, US

(73) Assignee: ATOMIC ENERGY COUNCIL-INSTITUTE OF NUCLEAR ENERGY RESEARCH, Taoyuan (TW)

(21) Appl. No.: 11/488,657

(22) Filed: Jul. 19, 2006

(51) Int. Cl. B01J 21/18; H01M 4/88; B01J 23/42

(52) U.S. Cl. 502/185; 502/101; 502/339

(57) ABSTRACT

Platinum alloy electrocatalysts for membrane fuel cell applications are fabricated. Conductive carbon blacks are used as supports. The platinum alloy electrocatalysts have binary or multiple components. The components are obtained through a polyol reduction. The electrocatalysts are used as anode catalysts of membrane fuel cells.

### FIELD OF THE INVENTION

The present invention relates to a catalyst fabricating method; more particularly, relates to reducing platinum (Pt) alloy complex ions to Pt alloy particles each having a granular size between 2 and 6 nanometers (nm) adhering on the conductive carbon black through a chemical reduction reaction so as to obtain a Pt alloy electrocatalyst using a conductive carbon black as a support with a easily control led composition.

### DESCRIPTION OF THE RELATED ARTS

Membrane fuel cells, including direct methanol fuel cell (DMFC) and proton exchange membrane fuel cell (PEMFC), are currently under development for uses as advanced electrochemical power devices. These power devices generally use proton exchange membranes, such as Nafion membranes, as solid electrolytes. The advantages of a membrane fuel cell include high energy density, high energy conversion efficiency, simple structure, long lifetime and easy installing or carrying. They have great potentials to replace conventional batteries to be used in electrical automobiles, portable notebook computers, mobile phones or other electrical equipments.

In general, a membrane fuel cell uses Pt as a cathode catalyst to enhance reduction reaction of oxygen or air; and Pt alloy as anode catalyst to enhance reduction reaction of fuel. The Pt alloy is used as anode catalyst to prevent catalyst from being poisoned by carbon monoxide or intermediate products of methanol oxidation reaction when being operated under a low temperature environment (lower than 100 Celsius degrees). This is a critical issue for a membrane fuel cell to be successful. At this moment, a bi-component alloy of Pt—Ru (ruthenium) is one of the most popular anode catalysts. And other multiple alloys, such as Pt—Ru—Rh (rhodium) or Pt—Ru—Rh—Ir (iridium), have higher priorities among all studies in this field due to expected better catalyst efficiencies and better anti-poison capabilities. Regarding fabrication of a catalyst, a proper granular size and a good dispersion are very important. In addition, a proper composition for a Pt alloy electrocatalyst is a key factor. For example, when the ratio of the atom number for Pt—Ru is Pt:Ru=1:1, a better catalytic activity is obtained.

In general, Pt alloy electrocatalyst uses a conductive carbon black as a support, such as Cabot Vulcan XC72, due to its low cost, high conductivity, light weight and small granular size. It also benefits the fabrication of an electrode or a membrane electrode assembly.

But, until now, the Pt alloy electrocatalyst still has some disadvantages. Concerning the composition of the multi-component catalyst, it must be properly controlled within a best range. As to the membrane fuel cell, the efficient has to be further improved. Most seriously, the catalyst cost is still too high mainly due to patent monopoly on manufacturing. Hence, the prior arts do not fulfill users' requests on actual use.

### SUMMARY OF THE INVENTION

The main purpose of the present invention is to fabricate conductive carbon black-supported bi- or multi-component Pt alloy electrocatalysts with high coherent particle size and high dispersion; and to effectively control compositions of the Pt alloy electrocatalysts so as to further enhance performances of the electrocatalysts.

To achieve the above purpose, the present invention is a method of fabricating platinum alloy electrocatalysts for membrane fuel cell applications, where, with a conductive carbon black used as a support, a bi- or multi-component Pt alloy electrocatalyst is fabricated through steps of: (a) pouring a strong acid-treated or strong oxidant-treated conductive carbon black powder into an ethylene glycol solution; (b) processing the ethylene glycol solution through a supersonication and a high-speed stirring to form a ethylene glycol/carbon paste; (c) adding a proper amount of sodium hydrogen sulfite solution to an ethylene glycol solution of H₂PtCl₆.6H₂O, RuCl₃ or other noble metal salt and then adding the solution to be mixed with the ethylene glycol/carbon paste for obtaining a reaction solution; (d) using a Ca(OH)₂ solution or a NaOH solution to ad just a pH value of the reaction solution; (e) stirring the reaction solution into a well-mixed mixture to be heated for a reduction reaction of a Pt alloy catalyst; (f) filtering the reaction solution to obtain the carbon black for being washed with a de-ionized water; and (g) being hot-dried by an oven in a temperature higher than 100 Celsius degrees. Accordingly, a novel method of fabricating platinum alloy electrocatalysts for membrane fuel cell applications is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is a view showing the flow chart according to the present invention;

FIG. 2 is a view showing a zeta potential curve of the carbon black according to the present invention in comparison with that of the general carbon black; and

FIG. 3 is a view showing the operational curve of the anode catalyst in the second preferred embodiment in comparison with that of the general anode catalyst.

### DESCRIPTION OF THE PREFERRED EMBODIMENTS

The following descriptions of the preferred embodiments are provided to understand the features and the structures of the present invention.

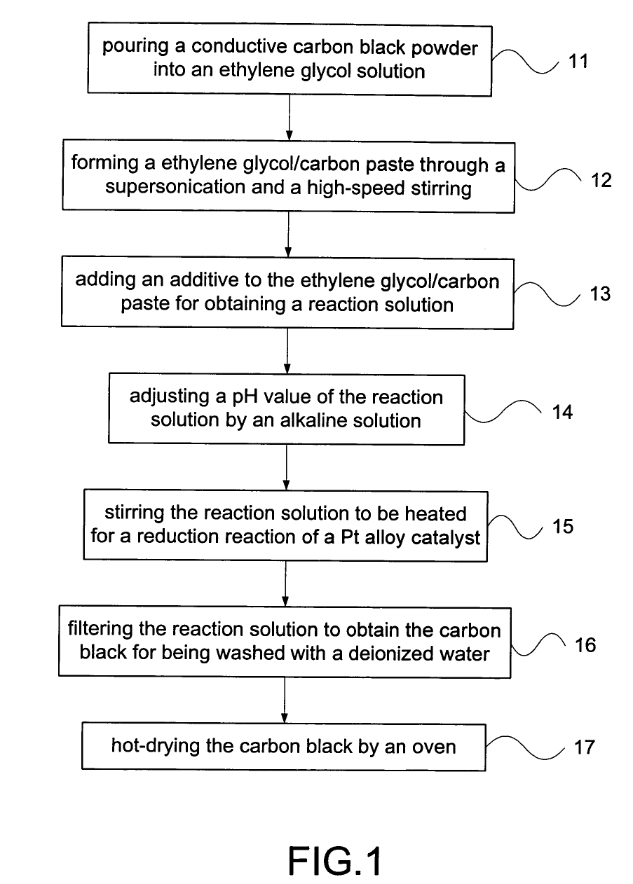

Please refer to FIG. 1, which is a view showing the flow chart according to the present invention. As shown in the figure, the present invention is a method of fabricating platinum alloy electrocatalysts for membrane fuel cell applications, where conductive carbon blacks are used as supports to fabricate bi- or multi-component Pt alloy electrocatalysts. The present invention comprises the following steps:

(a) Pouring a carbon black powder into an ethylene glycol solution 11: A conductive carbon black powder is processed through a strong acid, a nitric acid/sulfuric acid mixture, or a strong oxidant, such as ozone or potassium permanganate, in advance. Then the conductive carbon black powder is poured into an ethylene glycol solution. Therein, the conductive carbon black powder has a plurality of exchange functional groups which aids in exchanging and adhering of metal ions and forming catalyst nuclei; and, the conductive carbon black is Cabot Vulcan XC72, Vulcan XC72R, Black Pearl 2000 or other carbon black material.

(b) Forming a ethylene glycol/carbon paste through a supersonication and a high-speed stirring 12: The ethylene glycol solution having the conductive carbon black powder is processed with a supersonication and a high-speed stirring to form a ethylene glycol/carbon paste, where the supersonication is processed for 5 to 15 minutes (min) and the stirring is processed for 20 to 40 min.

(c) Adding an additive to the ethylene glycol/carbon paste for obtaining are action solution 13: An additive is added to an ethylene glycol solution of a noble metal salt containing Pt, like a chloroplatinic acid of H₂PtCl₆.6H₂O; and other noble metal salt, like ruthenium chloride (RuCl₃) or rhodium chloride (RhCl₃); and then the solution is added to be mixed with the ethylene glycol/carbon paste for obtaining a reaction solution. Therein, the additive is a sodium hydrogen sulfite (NaHSO₃) solution.

(d) Adjusting a pH value of the reaction solution by an alkaline solution 14: An alkaline solution is used to adjust a pH value of the reaction solution, where the alkaline solution is a calcium hydroxide (Ca(OH)₂) solution, a sodium hydroxide (NaOH) solution, a potassium hydroxide (KOH) solution or a magnesium hydroxide (Mg(OH)₂) solution; the pH value is adjusted to a value between 2.5 and 4.5; and the reaction solution has a water content between 0 and 10 volume percent (vol %). By doing so, a zeta potential on a surface of the conductive carbon black is adjusted to be located around an isoelectric point (IEP).

(e) Stirring the reaction solution to be heated for a reduction reaction of a Pt alloy catalyst 15: The reaction solution is processed with a high-speed stirring to obtain a mixed solution; then the mixed solution is heated for a reduction reaction of a Pt alloy catalyst, where the stirring is processed for 25 to 35 min. Therein, the heating is done with a microwave; the heating temperature is located between 110 and 150 Celsius degrees (° C.); and, the heating period is 30 min to 3 hours (hr). Or, the heating is done in a traditional way, like using an electric hot plate; the heating temperature is located between 110 and 150° C.; and, the heating period is 30 min to 5 hr. When using the micro wave, the solution is evenly heated and the temperature is easily raised so that the time for the reduction reaction is short and the Pt alloy catalyst obtained is evenly distributed and well dispersed. An initial material for the reduction reaction is a Pt salt, like a Pt chloride, a H₂PtCl₆.6H₂O or a platinum nitrate; or, is a Pt alloy salt, like a RuCl₃ salt, a RhCl₃ salt, a palladium chloride salt or an osmium chloride salt. An ethylene glycol solution is a main dispersant and reductant in the reduction reaction of the Pt alloy. And a NaHSO₃ solution is used as an assistant dispersant and reductant. The combined dispersant and reductant is more active for Pt alloy catalyst formation under an acid environment so that reduction efficiency is improved and reaction time is shortened. And, the complexing and dispersing of the metal ions are enhanced to control formation of Pt alloy particles.

(f) Filtering the reaction solution to obtain the carbon black for being washed with a deionized water 16: The conductive carbon black is filtered out from the solution; and then the carbon black is washed with a deionized water.

(g) Hot-drying the carbon black by an oven 17: An oven is used for a hot-drying to obtain a conductive carbon black-supported Pt alloy electrocatalyst with a high coherence and a high dispersion. Therein, the oven has a temperature between 100 and 110° C.; and, the conductive carbon black-supported Pt alloy electrocatalyst has a Pt alloy at a rate between 5 and 80 weight percents (wt %).

Thus, a novel method of fabricating Pt alloy electrocatalysts for membrane fuel cell applications is obtained.

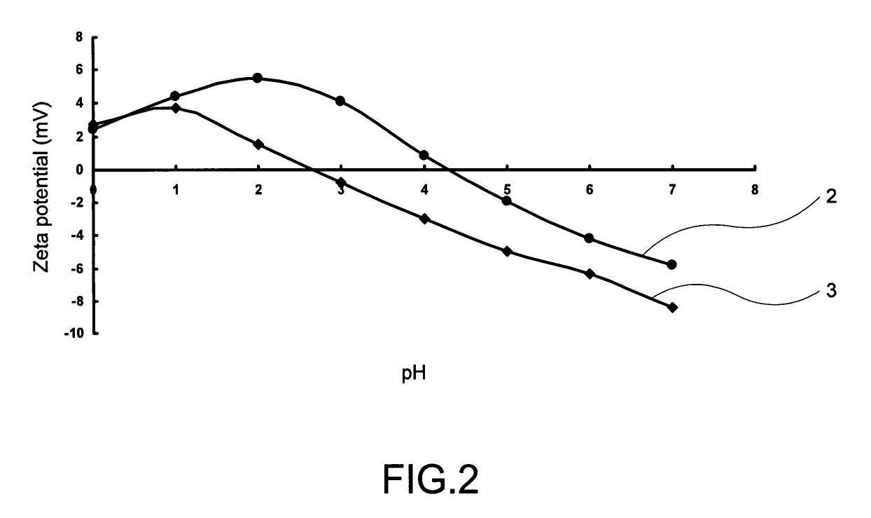

Please refer to FIG. 2, which is a view showing a zeta potential curve of a conductive carbon black according to the present invention in comparison with that of a general conductive carbon black. As shown in the figure, there are two curves: one is a first zeta potential curve 2 of a general conductive carbon black; and the other is a second zeta potential curve 3 of a conductive carbon black according to the present invention. At an IEP point having a zero zeta potential, all metal ions or complex ions have similar abilities to adhere on the surface of the conductive carbon black. Hence, by controlling a composition of the metal ion densities of the reaction solution, a requested composition of a bi- or multi-component Pt alloy electrocatalyst is obtained. In addition, by controlling a water content of the reaction solution, the Pt alloy catalyst is prevented from growing too big and is kept in a granular size between 2 and 6 nanometer (nm).

Thus, the catalyst of the present invention applied in a membrane fuel cell obtains a better performance. The conductive carbon black-supported platinum alloy electrocatalyst thus obtained is used as an anode catalyst in a DMFC or a proton exchange membrane fuel cell. The followings are preferred embodiments.

### [Embodiment 1] Preparing a Conductive Carbon Black-Supported Bi-Component Pt Alloy Electrocatalyst (Pt—Ru/C)

The first preferred embodiment is to prepare a bi-component Pt alloy electrocatalyst of 40 wt % Pt-20 wt % Ru/C (conductive carbon black) with an atom ratio of Pt:Ru=1:1, comprising the following steps:

(a) 0.471 gram (g) of a conductive carbon black powder, Cabot Vulcan XC72, is strong acid-treated and is poured into 35 milliliters (ml) of an ethylene glycol solution.

(b) The ethylene glycol solution is processed through a supersonication for 10 min; then is processed through a high-speed stirring for 30 min to obtain an ethylene glycol/carbon paste.

(c) 1,264 g of H₂PtCl₆.6H₂O and 0.506 g of RuCl₃ are dissolved into 10 g of an ethylene glycol solution. Then 1 milliliter (ml) of a NaHSO₃ solution having 1M density is added and the ethylene glycol/carbon paste is added to obtain a reaction solution.

(d) A pH value of a Ca(OH)₂ solution having a 2N density is adjusted to lie between 2.5 and 4.5 and is kept constantly.

(e) The adjusted reaction solution is processed through a high-speed stirring for 30 min; then is heated to 120° C. through a microwave to process a reduction reaction of Pt alloy for 30 min.

(f) The conductive carbon black is filtered out of the reaction solution to be washed with a deionized water.

(g) By using an oven, the conductive carbon black is hot-dried under 105° C. for 2 hr. Thus, a conductive carbon black-supported bi-component Pt alloy electrocatalyst is obtained.

After the fabricating steps are done, the reaction solution left after the filtering and the deionized water obtained after washing the conductive carbon black in step (f) are examined by an inductively coupled plasma-optical emission spectroscope (ICP-OES). An amount of metal ion left is calculated and thus obtain a reduction rate greater then 95%; and the atom number rate in the conductive carbon black-supported bi-component Pt alloy electrocatalyst is a bout Pt:Ru=1:0.93. It is rather ideal.

And, by using a transmission electron microscope, it is observed that the conductive carbon black-supported bi-component Pt alloy electrocatalyst has catalyst granules each having a diameter between 2 and 6 nm, 3.5 nm in average, which is very ideal to be used as an anode catalyst of a membrane fuel cell.

### [Embodiment 1] Preparing a Conductive Carbon Black-Supported Multi-Component Pt Alloy Electrocatalyst

The second preferred embodiment is to prepare a multi-component Pt alloy electrocatalyst of 40 wt % Pt-wt 20 wt % Ru-5 wt % Rh/C (conductive carbon black) with an atom ratio of Pt:Ru:Rh=1:1:0.125, comprising the following steps:

(a) 0.232 g of a conductive carbon black powder, Cabot Vulcan XC72, is strong acid-treated and is poured into 20 ml of an ethylene glycol solution.

(b) The ethylene glycol solution is processed through a supersonication for 10 min; then is processed through a high-speed stirring for 30 min to obtain an ethylene glycol/carbon paste.

(c) 0.60 g of H₂PtCl₆.6H₂O, 0.25 g of RuCl₃ and 0.10 g of RhCl₃ are dissolved into 8 g of an ethylene glycol solution. Then 1 ml of 10% of a NaHSO₃ solution and the ethylene glycol/carbon paste are added to obtain a reaction solution.

(d) A pH value of a Ca(OH)₂ solution having a 4N density is adjusted to lie between 2.5 and 4.5 and is kept constantly.

(e) The adjusted reaction solution is processed through a high-speed stirring for 30 min; then is heated to 120° C. through a microwave to process a reduction reaction of Pt alloy for 30 min.

(f) The conductive carbon black is filtered from the reaction solution to be washed with a deionized water.

(g) By using an oven, the conductive carbon black is hot-dried under 105° C. for 2 hr. Thus, a conductive carbon black-supported multi-component Pt alloy electrocatalyst is obtained.

After the fabricating steps are done, the reaction solution left after the filtering and the deionized water obtained after washing the conductive carbon black in step (f) are examined by an ICP-OES. An amount of metal ions left is calculated and thus obtain a reduction rate greater then 98%; and the atom number rate in the conductive carbon black-supported bi-component Pt alloy electrocatalyst is about Pt:Ru:Rh=1:0.94:0.124. It is also rather ideal. Moreover, the reaction temperature is higher and the reaction period is longer than the first preferred embodiment; consequently, a more complete reduction reaction is obtained.

And, by using a transmission electron microscope, it is observed that the conductive carbon black-supported multi-component Pt alloy electrocatalyst has catalyst granules each having a diameter between 2 and 6 nm, 3.7 nm in average, which is also very ideal to be used as an anode catalyst of a membrane fuel cell.

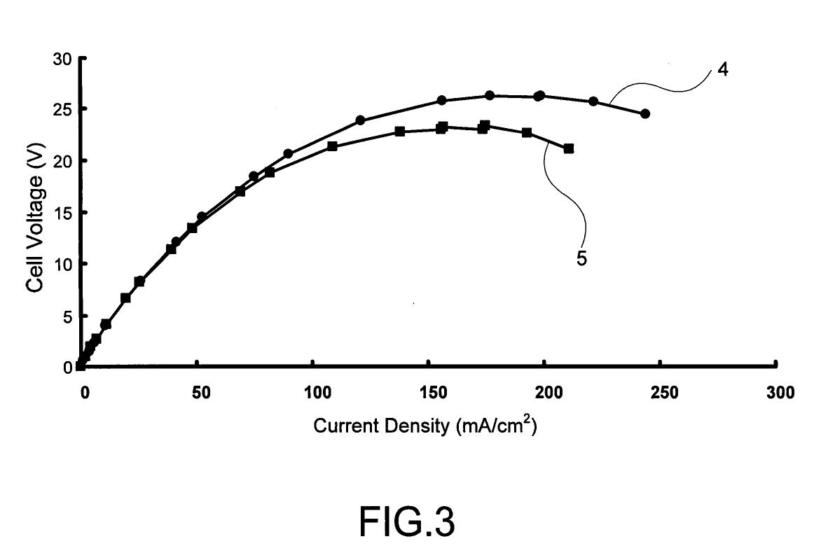

Please refer to FIG. 3, which is a view showing an operational curve of an anode catalyst in the second preferred embodiment in comparison with that of a general anode catalyst. As shown in the figure, a conductive carbon black-supported multi-component Pt alloy electrocatalyst of the second preferred embodiment is applied as an anode catalyst of a DMFC operated under 40° C. The anode catalyst is made of the Pt alloy electrocatalyst of the second preferred embodiment basically and is mixed with a proper amount of 5 wt % Nafion solution and then is coated on a water-proof carbon fabric having a loading capacity of 4 milligram per centimeter (mg/cm²). In the other end, a cathode catalyst is a gas permeable electrode of a merchandised Pt Black/C, having a loading capacity of 4 mg/cm² too. The two electrodes are hot-pressed with a proton exchange membrane (Nafion 117) to form a membrane electrode set. Then two graphite plates are obtained to assemble a DMFC having a single slot.

In the figure, there is a first curve 4 for an anode catalyst made through the above steps of the second preferred embodiment; and a second curve 5 for an anode catalyst of a merchandised Pt—Ru/C. From the two curves, it is obvious the performance of the second preferred embodiment is much better than that of the merchandised Pt—Ru/C. Hence, it is proved that the multi-component Pt alloy electrocatalyst of the second preferred embodiment is suitable to be used as an anode catalyst in a proton exchange membrane.

To sum up, the present invention is a method of fabricating Pt alloy electrocatalysts for membrane fuel cell applications, where conductive carbon black-supported Pt alloy electrocatalysts with high coherent granular sizes and high dispersions are obtained; and the performance of the membrane fuel cell applications is further enhanced by controlling the composition of the Pt alloy catalyst through the fabricating method.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of fabricating platinum alloy electrocatalysts for membrane fuel cell applications, comprising steps of:
(a) adding a powder of a conductive carbon black into a first ethylene glycol solution, said conductive carbon black being strong acid-treated;
(b) processing said first ethylene glycol solution through a supersonication and a stirring to obtain an ethylene glycol/carbon paste;
(c) obtaining a second ethylene glycol solution containing platinum (Pt) salt and a noble metal salt, adding an additive to said second ethylene glycol solution, and adding said second ethylene glycol solution into said ethylene glycol/carbon paste to obtain a reaction solution;
(d) adjusting a pH value of said reaction solution by an alkaline solution;
(e) stirring said reaction solution to obtain a mixture solution, and heating said mixture solution to process a reduction reaction of a Pt alloy catalyst;
(f) filtering said mixture solution to obtain said powder of said conductive carbon black to be washed with a de-ionized water; and
(g) hot-drying said powder of said conductive carbon black by an oven to obtain a conductive carbon black-supported platinum alloy electrocatalysts.

2. The method according to claim 1,
wherein said conductive carbon black is selected from a group consisting of Vulcan XC72, Vulcan XC72R and Black Pearl 2000.

3. The method according to claim 1,
wherein said supersonication in step (b) is processed for a period between 5 and 15 minutes (min).

4. The method according to claim 1,
wherein said stirring in step (b) is processed for a period between 20 and 40 min.

5. The method according to claim 1,
wherein said Pt salt is a chloroplatinic acid of H₂PtCl₆.6H₂O.

6. The method according to claim 1,
wherein said noble metal salt is selected from a group consisting of ruthenium chloride (RuCl₃) and rhodium chloride (RhCl₃).

7. The method according to claim 1,
wherein said additive is a sodium hydrogen sulfite (NaHSO₃) solution.

8. The method according to claim 1,
wherein said alkaline solution in step (d) is a solution of a material selected from calcium hydroxide (Ca(OH)₂), sodium hydroxide (NaOH), potassium hydroxide (KOH) and magnesium hydroxide (Mg(OH)₂).

9. The method according to claim 1,
wherein said reaction solution is adjusted to obtain a pH value between 2.5 and 4.5 in step (d).

10. The method according to claim 1,
wherein said reaction solution in step (d) has a water content between 0 and 10 volume percent (vol %).

11. The method according to claim 1,
wherein said stirring in step (e) is processed for a period between 25 and 35 min.

12. The method according to claim 1,
wherein said hot-drying in step (e) is processed with a microwave.

13. The method according to claim 1,
wherein said hot-drying in step (e) is processed with a traditional heating of an electric hot plate.

14. The method according to claim 1,
wherein said oven in step (g) has a temperature between 100 and 110 Celsius degrees (° C.).

15. The method according to claim 1,
wherein said conductive carbon black-supported platinum alloy electrocatalysts contains Pt alloy at a rate between 5 and 80 weight percent (wt %).

16. The method according to claim 1
wherein an initial Pt metal source for said reduction reaction of said Pt alloy catalyst is selected from a group consisting of platinum chloride, a chloroplatinic acid of H₂PtCl₆.6H₂O, and platinum nitrate.

17. The method according to claim 1,
wherein an initial alloy source for said reduction reaction of said Pt alloy catalyst is selected from a RuCl₃ salt, a RhCl₃ salt, a palladium chloride salt and an osmium chloride salt.

18. The method according to claim 1,
wherein said ethylene glycol is a dispersant and a reductant within said reduction reaction of said Pt alloy catalyst.
